(19) United States
(12) Patent Application Publication
(10) Pub. No.: US 2024/0217024 A1
(43) Pub. Date: Jul. 4, 2024

(54) ROBOT CONTROL DEVICE AND SPOT WELDING SYSTEM

(71) Applicant: FANUC CORPORATION, Yamanashi (JP)

(72) Inventor: Yasuhiro AMAGATA, Yamanashi (JP)

(73) Assignee: FANUC CORPORATION, Yamanashi (JP)

(21) Appl. No.: 18/554,970

(22) PCT Filed: Apr. 19, 2021
(86) PCT No.: PCT/JP2021/015874

§ 371 Date: Oct. 11, 2023

(51) Int. Cl. B23K 11/30; B23K 35/02

(52) U.S. Cl. CPC B23K 11/3009; B23K 35/0205

(57) ABSTRACT

The present invention provides a robot control device and a spot welding system that are capable of roughening the surfaces of electrodes without requiring additional special devices or effort. The robot control device controls the operation of a robot that comprises a spot welding gun having a pair of electrodes positioned facing each other. The robot control device has a robot operation control unit that moves the pair of electrodes of the spot welding gun to a blade polishing position so that the surfaces of the pair of electrodes are polished by a rotating blade of an electrode polishing device. The robot control device changed the position of the pair of electrodes in contact with the blade from the polishing position so as to scratch the surfaces of the pair of electrodes after the polishing by the blade.

### TECHNICAL FIELD

The present invention relates to a robot control apparatus and a spot welding system.

### BACKGROUND ART

Conventionally, it has been known to perform spot welding (resistance welding) by a robot equipped with a spot welding gun at the distal end of its arm. The spot welding gun performs spot welding at a predetermined welding point by sandwiching a workpiece, which is a welding target object made of a metal plate or the like, by a pair of electrodes and applying a current to the electrodes.

Recently, aluminum alloy has been used as material in order to reduce the weight of automobiles. It is known that, since the surface of aluminum alloy is covered with a film, a large current is required to spot weld aluminum alloy in comparison with a steel plate. When a large current is applied to electrodes to perform spot welding of aluminum alloy, the melted aluminum alloy adheres to electrode surfaces, and the electrode life is reduced. In order to prolong the electrode life, it is necessary to frequently polish the electrode surfaces. In the case of polishing the electrodes, however, it takes time to move the electrodes to the position of an electrode polishing apparatus and to perform polishing. Thus, from the viewpoint of shortening the time for welding work, it is disadvantageous to frequently polish the electrodes.

Conventionally, as methods for prolonging the electrode life, a method of roughening electrode surfaces (see, for example, Patent Documents 1 and 2), a method of forming concentric projections on electrode surfaces (see, for example, Patent Document 3), and the like are known. These methods make it unlikely for melted aluminum alloy to adhere to electrode surfaces, thereby making it possible to avoid frequent polishing of the electrode surfaces.
Patent Document 1: U.S. Pat. No. 4,972,047
Patent Document 2: U.S. Pat. No. 6,861,609
Patent Document 3: U.S. Pat. No. 8,436,269

### DISCLOSURE OF THE INVENTION

### Problems to be Solved by the Invention

The above conventional methods, however, require a special device, and time and effort because electrode surfaces are roughened by using a dedicated cutter or performing filing. Therefore, it is required to roughen electrode surfaces without the necessity of adding a special device, and time and effort.

### Means for Solving the Problems

One aspect of a robot control apparatus of the present disclosure is a robot control apparatus for controlling operation of a robot including a spot welding gun that has a pair of electrodes arranged to face each other. The robot control apparatus includes a robot operation control unit configured to cause the pair of electrodes to move to polishing positions for polishing by blade portions of an electrode polishing apparatus so that surfaces of the pair of electrodes are polished by the blade portions of the electrode polishing apparatus. The robot operation control unit changes positions of the pair of electrodes that are in contact with the blade portions from the polishing positions so that the surfaces of the pair of electrodes that have been polished by the blade portions are scratched.

One aspect of a spot welding system of the present disclosure includes: a spot welding gun including a pair of electrodes arranged to face each other; a robot configured to move the spot welding gun; an electrode polishing apparatus configured to polish surfaces of the pair of electrodes by rotating blade portions; and a robot control apparatus configured to control operation of the robot and the electrode polishing apparatus. The robot control apparatus includes a robot operation control unit that causes the pair of electrodes of the spot welding gun to move to polishing positions for polishing by the blade portions of the electrode polishing apparatus so that surfaces of the pair of electrodes are polished by the blade portions that are rotating. The robot operation control unit changes positions of the pair of electrodes that are in contact with the blade portions from the polishing positions so that the surfaces of the pair of electrodes that have been polished by the blade portions are scratched.

### Effects of the Invention

According to one aspect, it is possible to provide a robot control apparatus and a spot welding system that are capable of roughening electrode surfaces without the necessity of adding a special device, and time and effort.

### BRIEF DESCRIPTION OF THE DRAWINGS

FIG. 1 is a schematic configuration diagram of a spot welding system according to one embodiment;

FIG. 2 is a block diagram of the spot welding system according to one embodiment;

FIG. 3 is a side view showing blade portions of an electrode polishing apparatus;

FIG. 4 is a plan view showing the blade portions of the electrode polishing apparatus;

FIG. 5 is a side view showing a state of polishing electrodes by the blade portions of the electrode polishing apparatus;

FIG. 6 is a flowchart illustrating polishing operation of the electrodes in the spot welding system;

FIG. 7 is a side view illustrating a form of operation of roughening the surfaces of the electrodes by the blade portions of the electrode polishing apparatus;

FIG. 8 is a side view illustrating a form of operation of roughening the surfaces of the electrodes by the blade portions of the electrode polishing apparatus;

FIG. 9 is a diagram showing the surface of each electrode that has been roughened;

FIG. 10 is a side view illustrating another form of the operation of roughening the surfaces of the electrodes by the blade portions of the electrode polishing apparatus;

FIG. 11 is a side view illustrating that other form of the operation of roughening the surfaces of the electrodes by the blade portion of the electrode polishing apparatus; and

FIG. 12 is a side view showing another form of each electrode.

### PREFERRED MODE FOR CARRYING OUT THE INVENTION

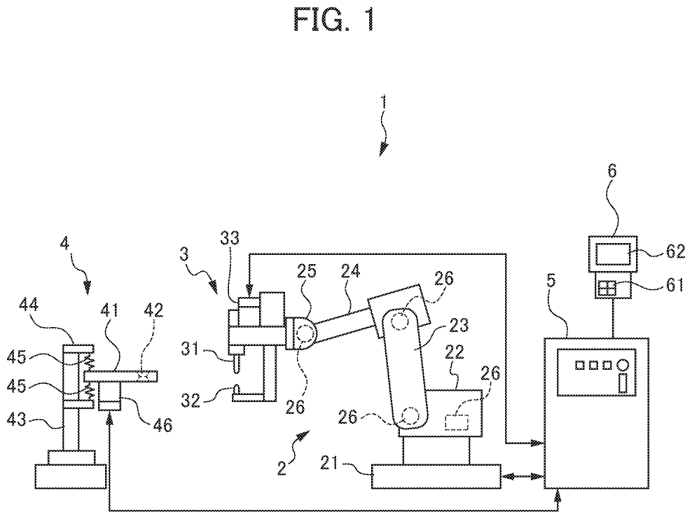

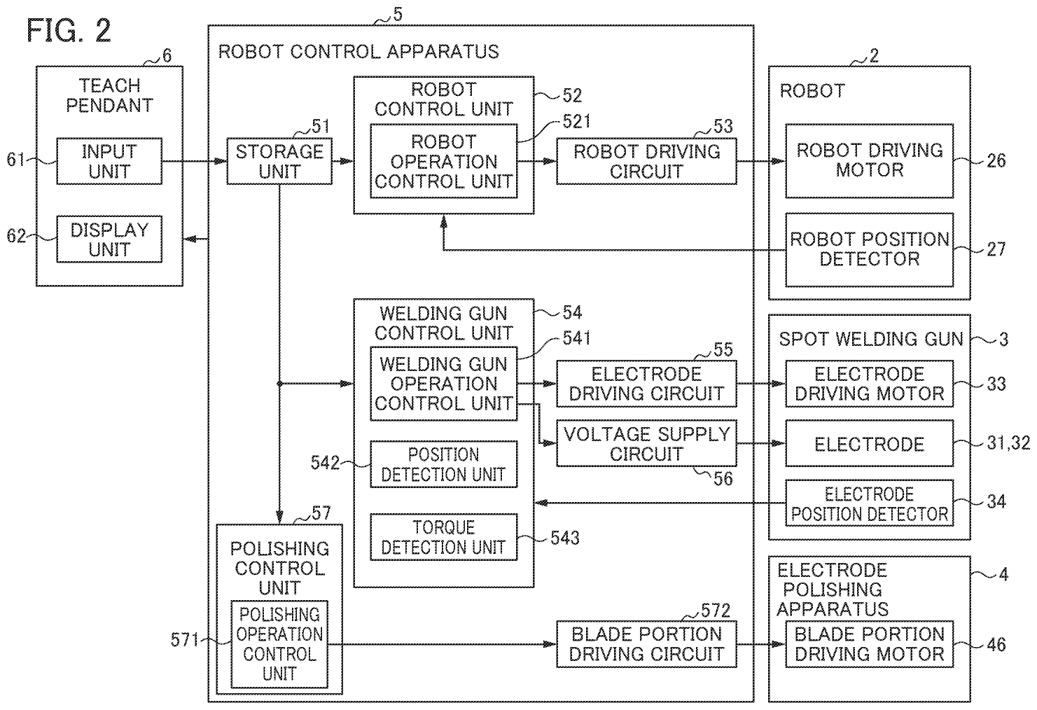

A robot control apparatus and a spot welding system according to one embodiment will be described below in detail with reference to drawings. FIG. 1 shows a schematic configuration diagram of the spot welding system according to one embodiment. FIG. 2 shows a block diagram of the spot welding system according to one embodiment.

A spot welding system 1 is provided with a robot 2 provided with a spot welding gun 3, an electrode polishing apparatus 4, a robot control apparatus 5, and a teaching pendant 6.

The robot 2 is a vertical articulated type robot with a plurality of joint portions. The robot 2 has a base 21 installed on the floor surface and a swivel 22 that is rotatable around an axis extending in the vertical direction. The robot 2 has a lower arm 23 that is rotatable being supported by the swivel 22, an upper arm 24 that is rotatable being supported on the distal end of the lower arm 23, and a wrist portion 25 that is rotatably supported on the distal end of the upper arm 24. The robot 2 has a plurality of robot driving motors 26 that individually drive the swivel 22, the lower arm 23, the upper arm 24, and the wrist portion 25, respectively. By the robot driving motors 26 driving the portions, respectively, the position and posture of the robot 2 change.

The robot is not limited to the form described above. The robot may be any robot that is capable of changing the position and posture of the spot welding gun 3.

The spot welding gun 3 is attached to the wrist portion 25 of the robot 2. The position and posture of the spot welding gun 3 are changed by the position and posture of the robot 2 changing. The spot welding gun 3 has a pair of electrodes configured with a movable electrode 31 and a counter electrode 32 arranged to face the movable electrode 31, and an electrode driving motor 33 that drives the movable electrode 31.

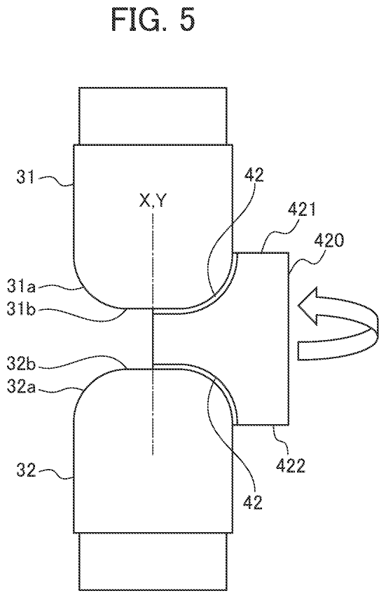

Each of the movable electrode 31 and the counter electrode 32 of the present embodiment is almost cylindrical. As shown in FIG. 5, the tips of the movable electrode 31 and the counter electrode 32 have rounded portions 31a and 32a obtained by rounding perimeter corner portions, and tip faces 31b and 32b configured with flat faces, respectively. Central axes Y of the movable electrode 31 and the counter electrode 32 coincide with each other. The movable electrode 31 moves in directions approaching and being away from the counter electrode 32, by being driven by the electrode driving motor 33. The spot welding gun 3 applies voltage between the movable electrode 31 and the counter electrode 32 to perform spot welding, in a state of sandwiching a workpiece (not shown), which is a welding target object, between the movable electrode 31 and the counter electrode 32. As the workpiece, aluminum alloy or metal including aluminum alloy can be preferably used.

The electrode polishing apparatus 4 is generally called a chip dresser. In the electrode polishing apparatus 4, “polishing” is widely interpreted. For example, grinding (removal machining) by cutters (blade portions 42) is included within a range treated as “polishing” in the electrode polishing apparatus 4. The electrode polishing apparatus 4 is installed within a movable range of the robot 2, on the floor surface where the robot 2 is installed. The electrode polishing apparatus 4 has a body portion 41 provided with the blade portions 42 that polish the movable electrode 31 and counter electrode 32 of the spot welding gun 3, and a support member 43 provided erectly in the vertical direction. The support member 43 supports the body portion 41 at a predetermined position. A bracket 44 is fixed to the support member 43. On the upper and lower sides of the body portion 41, springs 45 are arranged, respectively. The springs 45 are provided to expand and contract in the vertical direction. The body portion 41 is supported by the bracket 44 via the springs 45. The body portion 41 is freely movable in the vertical direction due to an elastic force of the springs 45.

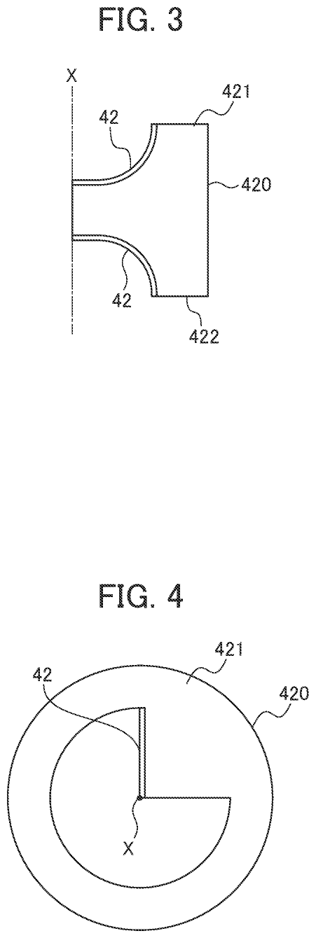

The body portion 41 of the electrode polishing apparatus 4 is provided to protrude in the side direction of the support member 43 from the bracket 44. The blade portions 42 are arranged at an end portion of the body portion 41 away from the bracket 44. The blade portions 42 are cutters for grinding the surfaces of the movable electrode 31 and counter electrode 32 of the spot welding gun 3. The blade portions 42 are supported by a cutter holder 420 as shown in FIGS. 3 to 5. The cutter holder 420 having the blade portions 42 is arranged inside a through hole that passes through the body portion 41 in the vertical direction.

The blade portions 42 of the present embodiment are arranged from an upper shoulder portion 421 and a lower shoulder portion 422 of the cutter holder 420 toward a rotational axis X. One blade portion 42 is provided for each of the movable electrode 31 and the counter electrode 32, in the cutter holder 420. The blade portions 42 have curved shapes that follow the shapes of the tips of the movable electrode 31 and the counter electrode 32. As shown in FIG. 5, when coming into contact with the surfaces of the movable electrode 31 and the counter electrode 32 to perform polishing, the blade portions 42 extend in the radial direction from the central axis Y of the movable electrode 31 and the counter electrode 32 along the tip faces 31b and 32b and the rounded portion 31a, respectively. The cutter holder 420 rotates around the rotational axis X extending in the vertical direction, by being driven by a blade portion driving motor 46 provided on the body portion 41. The central axis Y of the movable electrode 31 and the counter electrode 32 at the time of polishing coincides with the rotational axis X. As shown in FIG. 5, the blade portions 42 simultaneously polish the surfaces of the movable electrode 31 and the counter electrode 32 arranged to face each other, by rotation of the cutter holder 420.

The robot control apparatus 5 controls each of operation of the robot 2, operation of the spot welding gun 3 provided for the robot 2, and operation of the electrode polishing apparatus 4. The robot control apparatus 5 is configured with an arithmetic processing apparatus having a CPU (central processing unit), a RAM (random access memory), a ROM (read-only memory), and the like that are mutually connected via a bus. The robot 2, the spot welding gun 3, and the electrode polishing apparatus 4 are electrically connected to the robot control apparatus 5 via a communication device.

As shown in FIG. 2, the robot control apparatus 5 has a storage unit 51 that stores information about control of each of the robot 2, the spot welding gun 3, and the electrode polishing apparatus 4. Operation programs about operation of each of the robot 2, the spot welding gun 3, and the electrode polishing apparatus 4 is stored in the storage unit 51. The operation of the robot 2, the spot welding gun 3, and the electrode polishing apparatus 4 includes operation of electrode polishing and operation of electrode surface roughening described later.

The robot control apparatus 5 has a robot control unit 52 that controls the robot 2. The robot control unit 52 has a robot operation control unit 521 that controls each of the plurality of robot driving motors 26 of the robot 2. The robot operation control unit 521 sends an operation instruction based on the operation program to a robot driving circuit 53. The robot driving circuit 53 supplies a drive current based on the operation instruction to each of the robot driving motors 26.

The robot 2 has a robot position detector 27 for detecting the position and posture of the robot 2. The robot position detector 27 of the present embodiment has rotation position detectors (not shown) attached to the robot driving motors 26, respectively. The robot control unit 52 receives a signal about a rotation position outputted from the robot position detector 27. Thereby, the robot control unit 52 can detect the position and posture of the spot welding gun 3 based on the position and posture of the robot 2.

The robot control apparatus 5 has a welding gun control unit 54 that controls the spot welding gun 3. The welding gun control unit 54 has a welding gun operation control unit 541 that performs control of the electrode driving motor 33 of the spot welding gun 3 and control of voltage to be applied to the electrodes (the movable electrode 31 and the counter electrode 32). The welding gun operation control unit 541 sends an operation instruction based on the operation program to each of an electrode driving circuit 55 and a voltage supply circuit 56. The electrode driving circuit 55 supplies a drive current based on an operation instruction to cause the movable electrode 31 to move, to the electrode driving motor 33. The voltage supply circuit 56 supplies voltage based on an operation instruction for spot welding, to the movable electrode 31 and the counter electrode 32.

The welding gun control unit 54 has a position detection unit 542 that detects the position of the movable electrode 31 relative to the counter electrode 32. The spot welding gun 3 has an electrode position detector 34 for detecting the position of the movable electrode 31. The electrode position detector 34 of the present embodiment has a rotation position detector (not shown) attached to the electrode driving motor 33. The position detection unit 542 detects the position of the movable electrode 31 relative to the counter electrode 32, based on an output from the electrode position detector 34.

The welding gun control unit 54 has a torque detection unit 543 that detects torque outputted by the electrode driving motor 33. The torque detection unit 543 can detect the torque outputted by the electrode driving motor 33, for example, based on an operation instruction to control the electrode driving motor 33. Or alternatively, a current detector that detects a current value supplied to the electrode driving motor 33 can be arranged in the spot welding gun 3. The torque detection unit 543 may detect the torque based on a current value detected by the current detector. Thereby, the torque detection unit 543 can detect a pressing force of the movable electrode 31 toward the counter electrode 32.

The robot control apparatus 5 has a polishing control unit 57 that controls the electrode polishing apparatus 4. The polishing control unit 57 has a polishing operation control unit 571 for controlling the blade portion driving motor 46 of the electrode polishing apparatus 4. The polishing operation control unit 571 sends an operation instruction based on the operation program for polishing operation, to a blade portion driving circuit 572. The blade portion driving circuit 572 supplies a drive current based on the operation instruction, to the blade portion driving motor 46.

As shown in FIGS. 1 and 2, the robot control apparatus 5 has the teaching pendant 6 connected via the communication device. The teaching pendant 6 has an input unit 61 that inputs information about the robot 2, the spot welding gun 3, and the electrode polishing apparatus 4. A worker can input the operation program about the position and posture of the spot welding gun 3 based on the taught position and posture of the robot 2, the operation program about operation of the electrode polishing apparatus 4, and the like to the robot control apparatus 5 by the input unit 61. The input unit 61 is configured with a keyboard, a dial, and the like. The teaching pendant 6 has a display unit 62 that displays information about the robot 2, the spot welding gun 3, and the electrode polishing apparatus 4.

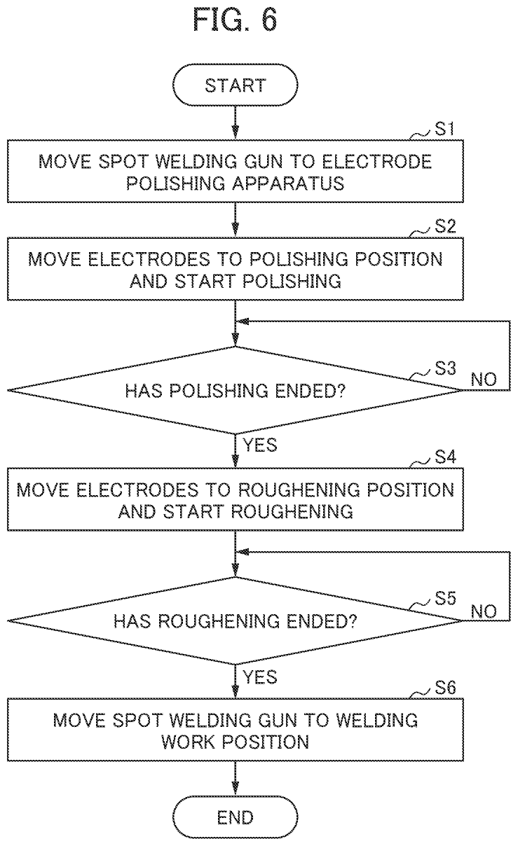

Next, description will be made on work of polishing the movable electrode 31 and the counter electrode 32 of the spot welding gun 3 in the spot welding system 1, using a flowchart shown in FIG. 6. After polishing the surfaces of the movable electrode 31 and counter electrode 32 of the spot welding gun 3 using the blade portions 42, the spot welding system 1 of the present embodiment roughens the surfaces of the movable electrode 31 and the counter electrode 32. The spot welding system 1 executes roughening machining of the surfaces of the movable electrode 31 and the counter electrode 32 using the same blade portions 42 used at the time of polishing the movable electrode 31 and the counter electrode 32.

At an appropriate timing during predetermined welding work by the spot welding gun 3, the robot control apparatus 5 changes the position and posture of the robot 2 from a welding position to cause the spot welding gun 3 to move to a position of the electrode polishing apparatus 4 decided in advance by the operation program, by control of the robot operation control unit 521 (Step S1).

After the spot welding gun 3 has moved to the predetermined position of the electrode polishing apparatus 4, the robot control apparatus 5 drives the electrode driving motor 33 to cause the movable electrode 31 and the counter electrode 32 to move to predetermined polishing positions where the blade portions 42 are sandwiched as shown in FIG. 5, by control of the welding gun operation control unit 541. After that, the robot control apparatus 5 drives the blade portion driving motor 46 to cause the cutter holder 420 to rotate to start polishing of the surfaces of the movable electrode 31 and the counter electrode 32 by the blade portions 42 rotating around the rotational axis X, by control of the polishing operation control unit 571 (Step S2). By the rotating blade portions 42, melted metal adhering to the surfaces of the movable electrode 31 and the counter electrode 32 are ground and removed.

The electrode polishing is performed by sandwiching the rotating blade portions 42 between the movable electrode 31 and the counter electrode 32 with a predetermined pressing force. The robot control apparatus 5 controls driving of the electrode driving motor 33 by the welding gun control unit 54 so that the pressing force of the movable electrode 31 toward the counter electrode 32, which is detected by the torque detection unit 543 of the welding gun control unit 54, becomes a predetermined pressing force required to perform the polishing based on the operation program.

The polishing of the movable electrode 31 and the counter electrode 32 by the rotating blade portions 42 is continuously executed for a predetermined time based on the operation program. The robot control apparatus 5 monitors whether the polishing has ended or not based on the operation program (Step S3). If judging that the polishing has not ended (in the case of NO at Step S3), the robot control apparatus 5 causes the polishing to continue.

If judging that the polishing has ended (in the case of YES at Step S3), the robot control apparatus 5 changes the position and posture of the robot 2, causes the movable electrode 31 and counter electrode 32 of the spot welding gun 3 to move to a roughening position determined in advance by the operation program, and starts roughening machining, by control of the robot operation control unit 521 (Step S4).

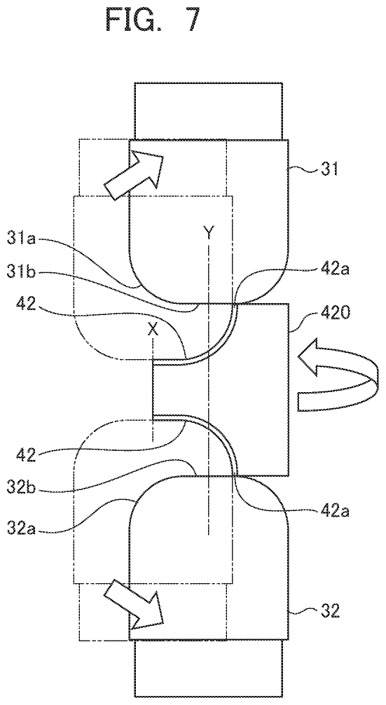

When the roughening machining is started, the robot control apparatus 5 causes the movable electrode 31 to move in a direction away from the counter electrode 32, and causes each of the movable electrode 31 and the counter electrode 32 to be away from the blade portions 42 to release the sandwiching of the blade portions 42, by control of the welding gun operation control unit 541 and the robot operation control unit 521 as shown in FIG. 7. Furthermore, the robot control apparatus 5 changes the position and posture of the robot 2 to change the position and posture of the spot welding gun 3 so that the tip faces 31b and 32b of the movable electrode 31 and the counter electrode 32 come into contact with corner portions 42a of the blade portions 42, by control of the robot operation control unit 521. The corner portions 42a of the blade portions 42 are arranged at extreme end portions (the upper end portion and the lower end portion) of the blade portions 42 along the rotational axis X, respectively. The corner portions 42a are arranged at end portions of the blade portions 42 adjacent to the upper shoulder portion 421 and lower shoulder portion 422 of the cutter holder 420, respectively. After the roughening machining is started, the blade portions 42 continuously rotate.

In the present embodiment, the movable electrode 31 and the counter electrode 32 for which roughening machining is performed are arranged at positions away from each other by a distance corresponding to the height of the cutter holder 420 along the rotational axis X (a distance between the upper shoulder portion 421 and the lower shoulder portion 422). The movable electrode 31 and the counter electrode 32 away from each other move in parallel such that the central axis Y is deviated from the rotational axis X, and causes the tip faces 31b and 32b to come into contact with the corner portions 42a of the blade portions 42. The movable electrode 31 and the counter electrode 32 at this time give only pressing forces smaller than the pressing forces at the time of polishing, to the blade portions 42. Or alternatively, the movable electrode 31 and the counter electrode 32 substantially do not give pressing forces to the blade portions 42. The tip faces 31b and 32b of the movable electrode 31 and the counter electrode 32 come into contact with the corner portions 42a of the blade portions 42 only lightly.

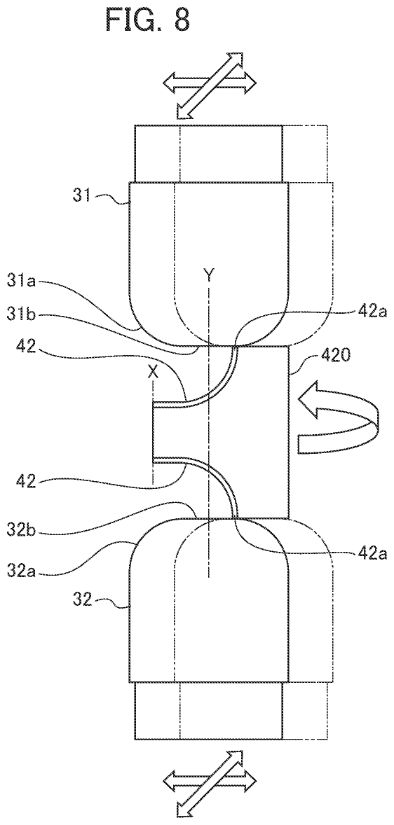

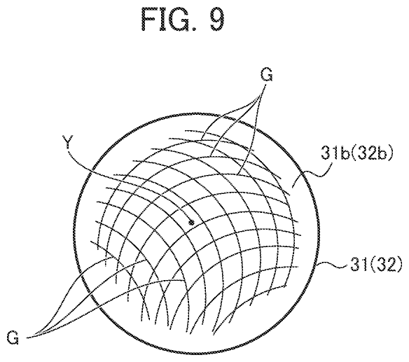

The tip faces 31b and 32b of the movable electrode 31 and the counter electrode 32 that have come into contact with the corner portions 42a of the blade portions 42 are scratched in lines by rotation of the blade portions 42. Thereby, minute linear grooves are formed on the tip faces 31b and 32b. The robot control apparatus 5 causes the positions of the movable electrode 31 and the counter electrode 32 relative to the corner portions 42a of the blade portions 42 to change in various directions within planes parallel to the tip faces 31b and 32b as shown in FIG. 8, by control of the robot operation control unit 521. Thereby, a plurality of minute linear grooves G extending in the plurality of directions are formed on the tip faces 31b and 32b of the movable electrode 31 and the counter electrode 32 by the corner portions 42a of the blade portions 42 as shown in FIG. 9, and the surfaces of the movable electrode 31 and the counter electrode 32 are roughened.

The pitch between adjacent grooves G is adjusted by appropriately adjusting the rotation speed of the blade portions 42 and the movement speed of the movable electrode 31 and the counter electrode 32. The intersection angle between mutually intersecting grooves G is adjusted by appropriately adjusting the plurality of movement directions of the movable electrode 31 and the counter electrode 32. The movement of the movable electrode 31 and the counter electrode 32 at the time of forming the plurality of grooves G by the corner portions 42a of the blade portions 42 is not limited to linear movement but may be curved movement.

At the time of performing machining for scratching the tip faces 31b and 32b of the movable electrode 31 and the counter electrode 32 in lines, the robot control apparatus 5 may cause the movable electrode 31 and the counter electrode 32 to move in an axial direction (upward and downward directions in FIGS. 7 and 8) of the movable electrode 31 and the counter electrode 32 and in a direction orthogonal to the axial direction, by the robot operation control unit 521. According to the above, the plurality of linear grooves G can also be formed on curved surfaces like the rounded portions 31a and 32a of the movable electrode 31 and the counter electrode 32, by the corner portions 42a of the rotating blade portions 42.

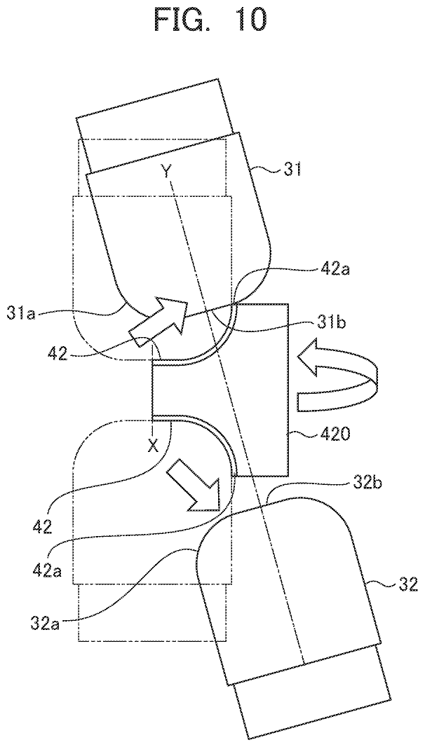

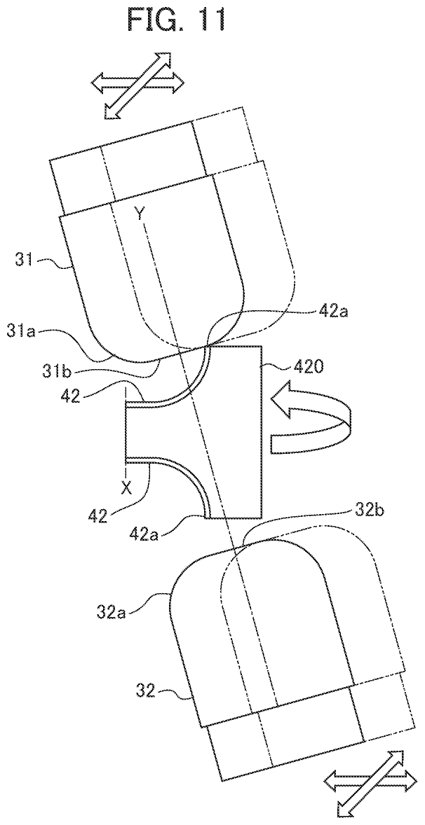

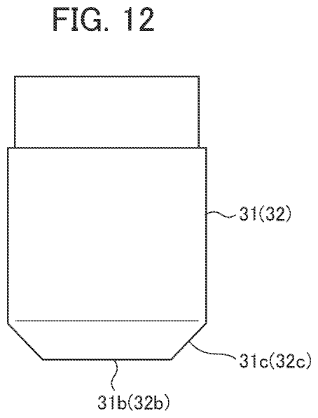

At the time of the roughening machining, the robot control apparatus 5 may perform control to change the position and posture of the spot welding gun 3 so that the central axis Y of the movable electrode 31 and the counter electrode 32 is tilted relative to the rotational axis X as shown in FIGS. 10 and 11, by the robot operation control unit 521. In this case, any of the corner portions 42a of the blade portions 42 comes into contact with the tip face 31b of the movable electrode 31 or the tip face 32b of the counter electrode 32. The robot control apparatus 5 causes the position of the movable electrode 31 or the counter electrode 32 relative to the corner portion 42a of the blade portion 42 to change in various directions within a plane parallel to the tip face 31b and 32b to roughen the tip face 31b or 32b as shown in FIG. 11, by control of the robot operation control unit 521.

In this method, though it is necessary to perform roughening machining individually for each of the movable electrode 31 and the counter electrode 32, clear grooves G can be formed on the tip faces 31b and 32b because it is possible to cause the corner portions 42a of the blade portions 42 to sharply come into contact with the tip faces 31b and 32b.

The robot control apparatus 5 monitors whether the roughening machining has ended or not based on the operation program (Step S5). If judging that the roughening machining has not ended (in the case of NO at Step S5), the robot control apparatus 5 causes the roughening machining to continue.

If judging that the roughening machining has ended (in the case of YES at Step S5), the robot control apparatus 5 changes the position and posture of the robot 2, causes the spot welding gun 3 to move to a welding work position determined in advance by the operation program, and starts next welding work, by the robot operation control unit 521 (Step S6). Thereby, the polishing work for the movable electrode 31 and the counter electrode 32 ends.

According to the robot control apparatus 5 of the present embodiment, the following effects are obtained. The robot control apparatus 5 controls operation of the robot 2 including the spot welding gun 3, the spot welding gun 3 including the pair of the movable electrode 31 and the counter electrode 32 arranged to face each other. The robot control apparatus 5 includes the robot operation control unit 521 that causes the movable electrode 31 and counter electrode 32 to move to the polishing positions for polishing by the blade portions 42 so that the surfaces of the movable electrode 31 and the counter electrode 32 of the spot welding gun 3 are polished by the rotating blade portions 42 of the electrode polishing apparatus 4. The robot operation control unit 521 changes positions of the movable electrode 31 and the counter electrode 32 that are in contact with the blade portions 42 from the polishing positions so that the tip faces 31b and 32b of the movable electrode 31 and the counter electrode 32 that have been polished by the blade portions 42 are scratched. Thereby, it is possible to roughen the surfaces of the movable electrode 31 and the counter electrode 32 that have been polished by the rotating blade portions 42, using the same blade portions 42. It is possible to roughen the surfaces of the movable electrode 31 and the counter electrode 32 without the necessity of adding a special device, and time and effort for roughening the surface of the movable electrode 31 and the counter electrode 32.

In the present embodiment, the robot operation control unit 521 causes the movable electrode 31 and the counter electrode 32 to move so that the surfaces of the movable electrode 31 and the counter electrode 32 are scratched while changing the positions of the movable electrode 31 and the counter electrode 32 that are in contact with the blade portions 42. Thereby, a plurality of minute linear grooves extending in a plurality of directions are formed on the movable electrode 31 and the counter electrode 32. Therefore, it is possible to easily roughen the surfaces of the movable electrode 31 and the counter electrode 32.

In the present embodiment, at the time of scratching the surfaces of the movable electrode 31 and the counter electrode 32, the robot operation control unit 521 can cause the movable electrode 31 and the counter electrode 32 to move in the axial direction of the movable electrode 31 and the counter electrode 32 and in the direction orthogonal to the axial direction. Thereby, it is possible to form the linear grooves G on curved surfaces like the rounded portions 31a and 32a of the movable electrode 31 and the counter electrode 32 to roughen the curved surfaces.

In the present embodiment, at the time of scratching the surfaces of the movable electrode 31 and the counter electrode 32, the robot operation control unit 521 causes the movable electrode 31 and the counter electrode 32 to move so that the surfaces of the movable electrode 31 and the counter electrode 32 come into contact with the corner portions 42a of the blade portions 42. According to the above, it is possible to, without making change in the blade portions 42 for performing polishing, easily roughen the surfaces of the movable electrode 31 and the counter electrode 32 using the blade portions 42.

In the present embodiment, machining of scratching the surfaces of the movable electrode 31 and the counter electrode 32 is roughening machining. According to the above, it is possible to easily roughen the surfaces of the movable electrode 31 and the counter electrode 32 by scratching the surfaces of the movable electrode 31 and the counter electrode 32 using the blade portions 42 for performing polishing.

The spot welding system 1 of the present embodiment includes: the spot welding gun 3 including the pair of the movable electrode 31 and the counter electrode 32 arranged to face each other; the robot 2 that moves the spot welding gun 3; the electrode polishing apparatus 4 that polishes the surfaces of the pair of the movable electrode 31 and the counter electrode 32 by the rotating blade portions 42; and the robot control apparatus 5 that controls operation of the robot 2 and the electrode polishing apparatus 4. The robot control apparatus 5 includes the robot operation control unit 521 that causes the movable electrode 31 and the counter electrode 32 of the spot welding gun 3 to move to the polishing positions for polishing by the blade portions 42 so that the surfaces of the pair of the movable electrode 31 and the counter electrode 32 are polished by the rotating blade portions 42 of the electrode polishing apparatus 4. The robot operation control unit 521 changes positions of the pair of the movable electrode 31 and the counter electrode 32 that are in contact with the blade portions 42 from the polishing positions so that the surfaces of the movable electrode 31 and the counter electrode 32 that have been polished by the blade portions 42 are scratched. Thereby, it is possible to roughen the surfaces of the movable electrode 31 and the counter electrode 32 that have been polished by the rotating blade portions 42, using the same blade portions 42. It is possible to roughen the surfaces of the movable electrode 31 and the counter electrode 32 without the necessity of adding a special device, and time and effort for roughening the surface of the movable electrode 31 and the counter electrode 32.

The movable electrode 31 and the counter electrode 32 of the present embodiment have the rounded portions 31a and 32a obtained by rounding perimeter corner portions but are not limited to such a form. The movable electrode 31 and the counter electrode 32 may have chamfer portions 31c and 32c obtained by beveling the perimeter corner portions.

On the spot welding gun 3 of the present embodiment, the movable electrode 31 is provided being movable in the directions approaching and being away from the counter electrode 32, but the spot welding gun 3 is not limited to such a form. Both of the paired electrodes of the spot welding gun may be movably provided.

The electrode polishing apparatus 4 of the present embodiment is configured to be capable of polishing and roughening both of the movable electrode 31 and the counter electrode 32 at the same time, but the electrode polishing apparatus 4 is not limited to such a form. The electrode polishing apparatus may be configured to polish and roughen the pair of electrodes one by one.

The spot welding system 1 of the present embodiment is configured to control the robot 2, the spot welding gun 3, and the electrode polishing apparatus 4 by the one robot control apparatus 5, but the spot welding system 1 is not limited such a form. The electrode polishing apparatus 4 may be configured to be controlled by a dedicated control apparatus different from the robot control apparatus 5.

### EXPLANATION OF REFERENCE NUMERALS

1 Spot welding system
2 Robot
3 Spot welding gun
31 Movable electrode
32 Counter electrode
4 Electrode polishing apparatus
42 Blade portion
42a Corner portion
5 Robot control apparatus
521 Robot operation control unit

1. A robot control apparatus for controlling operation of a robot comprising a spot welding gun that has a pair of electrodes arranged to face each other, the robot control apparatus comprising:
a robot operation control unit configured to cause the pair of electrodes of the spot welding gun to move to polishing positions for polishing by blade portions of an electrode polishing apparatus so that surfaces of the pair of electrodes are polished by the blade portions of the electrode polishing apparatus, wherein
the robot operation control unit changes positions of the pair of electrodes that are in contact with the blade portions from the polishing positions so that the surfaces of the pair of electrodes that have been polished by the blade portions are scratched.

2. The robot control apparatus according to claim 1, wherein
the robot operation control unit causes the pair of electrodes to move so that the surfaces of the pair of electrodes are scratched while changing the positions of the pair of electrodes that are in contact with the blade portions.

3. The robot control apparatus according to claim 1, wherein,
when scratching the surfaces of the pair of electrodes, the robot operation control unit causes the pair of electrodes to move in an axial direction of the pair of electrodes and in a direction orthogonal to the axial direction.

4. The robot control apparatus according to claim 1, wherein
when scratching the surfaces of the pair of electrodes, the robot operation control unit causes the pair of electrodes to move so that the surfaces of the pair of electrodes come into contact with corner portions of the blade portions.

5. The robot control apparatus according to claim 1, wherein
machining of scratching the surfaces of the electrodes is roughening machining.

6. A spot welding system comprising:
a spot welding gun comprising a pair of electrodes arranged to face each other;
a robot configured to move the spot welding gun;
an electrode polishing apparatus configured to polish surfaces of the pair of electrodes by rotating blade portions; and
a robot control apparatus configured to control operation of the robot and the electrode polishing apparatus, wherein
the robot control apparatus comprises a robot operation control unit that causes the pair of electrodes of the spot welding gun to move to polishing positions for polishing by the blade portions of the electrode polishing apparatus so that surfaces of the pair of electrodes are polished by the blade portions that are rotating, and
the robot operation control unit changes positions of the pair of electrodes that are in contact with the blade portions from the polishing positions so that the surfaces of the pair of electrodes that have been polished by the blade portions are scratched.
